(19) United States
(12) Patent Application Publication
(10) Pub. No.: US 2005/0219580 A1
(43) Pub. Date: Oct. 6, 2005

(54) Image processing method, image processing system, image processing apparatus and image processing program

(75) Inventor: Satoshi Ozawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/064,942

(22) Filed: Feb. 25, 2005

(30) Foreign Application Priority Data
Feb. 25, 2004 (JP) 2004-048941

(51) Int. Cl. G06K 15/00; H04N 1/409; H04N 1/58; H04N 1/60

(52) U.S. Cl. 358/1.9; 358/3.26; 358/3.27; 358/527; 358/518

(57) ABSTRACT

A simplified initial image data is generated by thinning out an initial image data, which is obtained by shooting, at a predetermined rate. Image correction is performed to the simplified initial image data by using predetermined development parameters, and the simplified initial image data is converted into a simplified display image which is displayable in a monitor. An operator changes the development parameters while observing the simplified display image. Every time the development parameters are changed, the image correction with using changed development parameters is performed to the simplified initial image data, and the simplified display image is updated and displayed. The initial image data is subjected to the image correction with determined development parameters, and output after being converted into display image data.

### BACKGROUND OF THE INVENTION

1. Field of the Invention

The present invention relates to an image processing method, an image processing system, an image processing apparatus and an image processing program for performing various image processing while reproducing and displaying digital images according to initial image data (CCD-RAW image data) sent from an image taking apparatus such as a digital camera.

2. Background Arts

To improve image quality of digital images, it is effective to correct images by adjusting parameters (correction parameters) of color balance, white balance, and tone curve of the digital images by using an information processing terminal such as a personal computer (PC). For instance, when the image is taken by a digital camera, the image data is sent from the digital camera to the PC. An operator can obtain intended images by image verification, in which various correction parameters are changed, while observing the images displayed in a monitor of the PC.

It is also possible to perform the image correction in the PC so as not to lose color informations in the digital camera by the use of a digital camera, which allows to output initial image data (RAW data) to the PC without the white balance correction and exposure compensation.

The initial image data is direct output from an image pickup device of the digital camera and cannot be displayed in the monitor without processing. To display the images in the monitor of the PC, it is necessary to perform the image correction to the initial image data according to parameters (hereinafter referred to as correction parameters) for the white balance and the exposure, and convert the initial image data into display image data (hereinafter referred to as development) of Tiff (Tagged Image File Format), for instance. However, data size of the initial image data is significantly large, since the initial image data is formed of pixel data, for instance, with 12 bits or 16 bits per color. Therefore, the development of the initial image data takes a long time. As a result, there arises a problem that the image verification takes a long time when the data size of the initial image data is large, since the development of the initial image data is repeated every time various development parameters are changed. Further, a load in the CPU becomes significantly high during the development. Therefore, other processing is stopped at the time the development is repeated by changing various development parameters.

In the conventional image verification, the operator selects each target image to be verified, and development parameters are changed for each target image. Therefore, it is concerned that it takes a long time when the image verification is performed to initial image data which has a large data size. Above all, to the images taken in the approximately same environment, for instance, in a studio, the development parameters will be the same. Nevertheless, it is inefficient to perform the image verification to each image.

Further, parameters for image adjustment, such as color correction and trimming, can be corrected concurrently with the above development parameters. In the conventional image verification, the image adjustment is performed to the initial image data every time the parameters for the image adjustment are changed along with the above development. Therefore, the image verification takes a long time.

Furthermore, the digital camera outputs the reduced image data, which is compressed in JPEG format, along with the initial image data. The reduced image data is displayed in a list during the image verification. However, colors of the image in JPEG format are often different from those of the display image, since the image in JPEG format is different from the display image in color space and the number of bits. As a result, the operator may recognize the colors different to the actual image when observing the reduced image during the image verification.

### SUMMARY OF THE INVENTION

An object of the present invention is to provide an image processing method, an image processing system, an image processing apparatus and image processing program for reducing time for image verification when various image correction is performed to initial image data.

The above and other objects of the present invention are achieved by generating a simplified initial image data by thinning out initial image data at a predetermined rate, and performing image correction to the simplified initial image data using a first correction parameter.

A reproducible and displayable simplified display image is generated from the corrected simplified initial image data. The first parameter is changeable by reproducing and displaying the simplified display image. The image correction is performed to the initial image data according to a determined first correction parameter and the display image data is generated.

Every time the first correction parameter is changed, the image correction is performed to the simplified initial image data according to the changed first correction parameter. Further, the simplified display image generated from the corrected simplified initial image data is reproduced and displayed.

After the first correction parameter is determined, it is also possible to perform the image correction to the reproduced and displayed simplified display image according to a second correction parameter, and the image correction is performed to the display image data according to a determined second correction parameter.

Every time the second correction parameter is changed, the image correction is performed to the simplified display image data according to the changed second correction parameter and the corrected simplified display image is reproduced and displayed.

Further, it is possible to change the first correction parameter with respect to initial image data corresponding to a first frame of the image, and the image correction can be performed to the initial image data corresponding to a second frame and on according to the determined first parameter.

It is also possible to change the first correction parameter with respect to the initial image data corresponding to one of plural images obtained by plural shooting, and the image correction is performed to the initial image data corresponding to the other selected frames according to the determined first correction parameter.

In the image processing method according to the present invention, one of a first processing mode and a second processing mode is selectable. The first processing mode enables to change the first correction parameter with respect to the initial image data corresponding to the first frame of the image, and the image correction is performed to the initial image data corresponding to a second and above frames. The second processing mode enables to change the first correction parameter with respect to the initial image data corresponding to one of the plural images obtained by the plural shootings, and the image correction is performed to the initial image data corresponding to other selected images according to the determined first correction parameter.

Further, reduced images corresponding to the initial image data are reproduced and displayed, and reduced images corresponding to the initial image data, which have not yet been subjected to the image correction, are displayed in black-and-white. Therefore, it is possible to prevent the operator from having incorrect color recognition in observing the reduced images which differ in color space and display colors.

The image processing system according to the present invention is constituted of an image shooting apparatus and an image processing apparatus, and includes a data thinning section, which is disposed in one of the image shooting apparatus and the image processing apparatus, for generating simplified initial image data by thinning out the initial image data at a predetermined rate.

An image processing apparatus according to the present invention includes a data thinning section, which generates the simplified initial image data by thinning out the initial image data at a predetermined rate, an image correction section, which performs the image correction to the simplified initial image data according to the first correction parameter and generates a reproducible and displayable simplified display image from the corrected simplified initial image data, and a reproduction and display section which makes the first correction parameter changeable by reproducing and displaying the simplified display image. The image correction section generates the display image data by performing the image correction to the initial image data according to the determined first correction parameter.

According to the present invention, the first correction parameter to the development is adjusted using the simplified initial image data, which is generated by thinning out the initial image data at a predetermined rate, with a small data size. Therefore, the time for the image processing is reduced. Further, it is not necessary to develop the initial image data in the image adjustments, so that the time for image processing is efficiently reduced.

### BRIEF DESCRIPTION OF THE DRAWINGS

The above objects and advantages of the present invention will become apparent from the following detailed descriptions of the preferred embodiments when read in association with the accompanying drawings, which are given by way of illustration only and thus do not limit the present invention. In the drawings, the same reference numerals designate like or corresponding parts throughout the several views, and wherein:

FIG. 1 is a block diagram schematically showing configurations of a digital camera and a PC for image verification;

FIG. 2 is a block diagram showing the function of the PC for the image verification;

FIG. 3 is an explanatory view showing an example of a image verifying screen;

FIG. 4 is an explanatory view showing another example of the image verifying screen;

FIG. 5 is a flowchart showing steps of an image verification using simplified initial image data;

FIG. 6 is a timing chart showing the steps of the image verification process to plural image frames; and

FIG. 7 is a timing chart showing another steps of the image verification process.

### DETAILED DESCRIPTION OF THE EMBODIMENTS

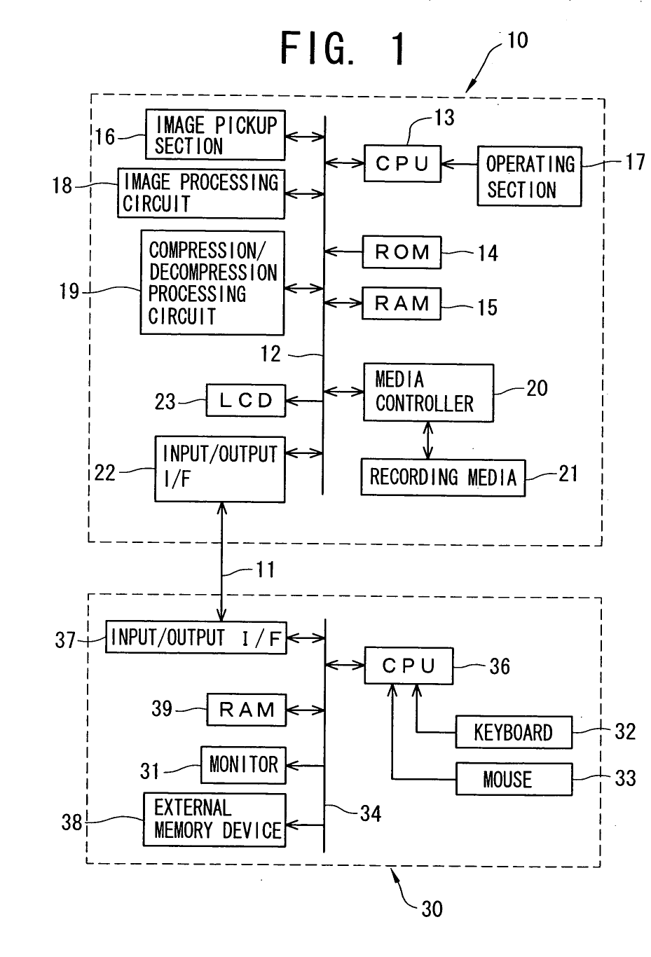

In FIG. 1, a digital camera 10 and a PC 30 for image correction are connected to each other via a communication cable 11 to send and receive camera control data and image data. As for the communication cable 11, for instance, a USB (Universal Serial Bus) communication cable or an IEEE 1394-compliant communication cable can be used. Wireless communication means can also be used for exchanging data instead of the communication cable 11. Commercially available personal computers, with preinstalled image verification program for performing various correction processing to taken digital images, is used for the PC 30 for image verification.

Each section of the digital camera 10 is interconnected via a data bus 12, and CPU 13 controls overall operation of the digital camera 10. A program for operating the digital camera 10 is recorded in ROM 14, and is loaded in RAM 15 when the digital camera 10 is turned on. An image pickup section 16 includes known taking lens, CCD and the like, and photoelectrically converts an optical image of a subject into a digital image data. Camera settings, such as an aperture and a shutter speed, can be set by operating various set-up buttons provided in an operating section 17. It is also possible to determine the camera settings by the PC 30 for the image verification, and transmit camera setting data to the digital camera 10 via the communication cable 11. Further, an additional PC may be connected to the digital camera 10 for controlling shooting.

Image data, which is output from the image pickup section 16, is buffered in the RAM 15. The image data is initial image data (CCD-RAW data), which has not been subjected to image correction such as white-balance processing, and constituted of a plurality of pixel data with gradation value of 12 bits or 16 bits per color. An image processing circuit 18 reduces the gradation value of the initial image data to 8 bits per color, and applies the image correction, such as white-balance processing and gradation conversion, to the image data according to predetermined conditions, which depends on a digital camera model, and outputs corrected image data.

A compression/decompression processing circuit 19 compresses the corrected image data according to a JPEG (Joint Photographic Coding Expert Group) format, and outputs compressed image data. Further, the compression/decompression processing circuit 19 generates JPEG image data (reduced image data) of, for instance, 1280×960 pixels by thinning operations of the corrected image data.

The initial image data is transmitted to the PC 30 for the image verification via an input and output I/F 22 along with the reduced image data. An LCD 23 continuously displays subject images in a shooting mode, and reproduces and displays images stored in a recording media 21 in a reproduction mode. In the embodiment, the initial image data is directly transmitted to the PC 30 for the image verification via the input and output I/F 22. However, it is also possible to transmit the initial image data to the PC 30 for the image verification by recording the initial image data in the recording media 21 and setting the recording media 21 in the PC 30 for the image verification.

The PC 30 for the image verification reproduces and displays an image on a monitor 31 according to the initial image data transmitted from the digital camera 10, and performs various image corrections to the displayed image in response to operation signals sent from input devices such as a keyboard 32 and a mouse 33. Each section of the PC 30 for the image verification is interconnected via a data bus 34, and CPU 36 controls overall operation of the PC 30 for the image verification. The initial image data transmitted from the digital camera 10 is recorded in an external memory device 38, such as a hard disk, via an input and output I/F 37 and the data bus 34. The input devices, such as the keyboard 32 and the mouse 33, are operated to perform the image correction, which will be described later, and to set the camera settings of the digital camera 10.

An image processing program is installed in the external memory device 38 of the PC 30 for the image verification via memory media such as a CD-ROM, a DVD-ROM and the like, or the Internet. When the image processing program is executed by operating the keyboard 32 and the mouse 33, the image processing program is loaded in the RAM 39 and executed.

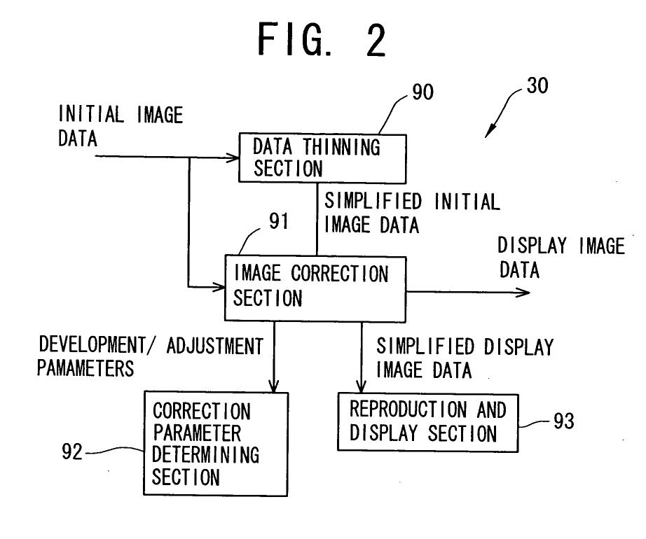

FIG. 2 shows a block diagram of main parts of the PC 30 for the image correction when the image correction program is executed. A data thinning section 90 generates simplified initial image data by thinning out the initial image data, which is sent from the digital camera 10, at a predetermined rate. An image correction section 91 performs the image correction to the simplified initial image data according to development parameters and adjustment parameters, which will be described later, and generates simplified display images for displaying in the monitor 31. The simplified display image is sent to a reproduction and display section 93, which includes the monitor 31, to be reproduced and displayed. The above development parameter and adjustment parameter correspond to a first parameter and a second parameter respectively, and are changed by a correction parameter determining section 92 which includes the keyboard 32 and the mouse 33. Further, when the development parameters and the adjustment parameters are determined, the image correction section 91 performs the image correction to the initial image data, and converts the initial image data into the display image data, which can be displayed in the monitor, and outputs the display image data.

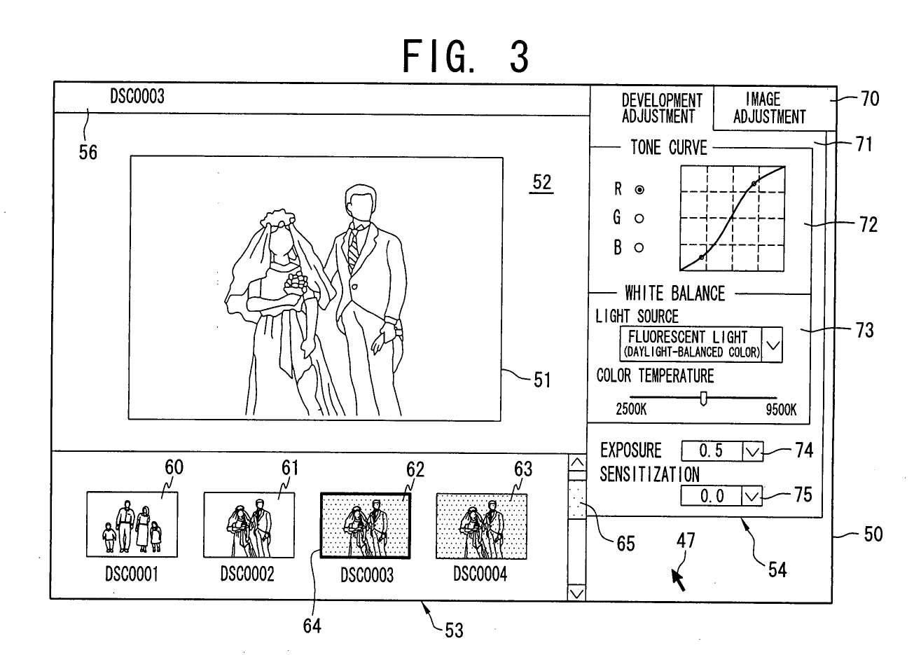

When the image processing program is executed, a verification screen 50 is displayed in the monitor 31 (see FIG. 3). The verification screen 50 includes a target image display area 52 for displaying a target image 51 to the image verification, a reduced image display area 53 for displaying plural reduced images in a row, and a parameter adjustment area 54. In an upper portion of the target image display area 52, a title bar 56, which displays a title (a file name) of the target image 51, is displayed. The image processing program generates the simplified initial image data by thinning out the initial image data in a predetermined proportion, and performs the image correction to the simplified initial image data by using an initial parameter predetermined by the image reproduction program, which will be described later. The target image 51 is based on the simplified initial image data converted into a Tiff format with the gradation value of 16 bits per color. Hereinafter, performing the image correction to the simplified initial image data and output the simplified display image data is referred to as temporary development. Further, performing the image correction to the initial image data and output the display image data is referred to as actual development.

In the reduced image display area 53, plural reduced images 60-63 are displayed in a row. Each of the reduced images 60-63 is reproduced and displayed according to corresponding reduced image data in JPEG format. In an example shown in FIG. 3, four frames of the reduced images are displayed. However, it is possible to properly increase or decrease a number of frames to be concurrently displayed. Further, a selecting cursor 64 is highlighted around the reduced image 62 which corresponds to the target image 51. Thereby, the target image 51 and the reduced image 62 are associated with each other. On the right side of the reduced image display area 53, a scroll bar 65, which is slidable in up-and-down directions, is disposed. When there are five and above frames of the reduced images to be displayed, the fifth and above frames can be displayed by sliding the scroll bar 65 in up-and-down directions.

Among the plural reduced images 60-63 displayed in the reduced image display area 53, the reduced images, which have not yet been subjected to the image verification (the reduced images 62 and 63 on the right side in FIG. 3), are displayed in black-and-white. The JPEG format image data, which is used for the reduced image, has smaller number of bits (8 bits per color), so that a number of displayable colors is small compared to the target image 51. An operator may have incorrect color recognition of the target image, since the display colors of the reduced images 60-63 and the target image 51 are different. The reduced image, which has already been verified (the reduced image 61, second from the left, for instance), and the reduced image excluded from the image verification (the reduced image 60 on the extreme left side, for instance) are displayed in full color.

In the parameter adjustment area 54, two types of screens are provided, one is for development condition adjustment, in which parameters for development (development parameters) are changed, and the other is for image adjustment, in which parameters for image adjustment (adjustment parameters) are changed, and the screen is switched by a changeover tab 70 displayed in an upper portion of the parameter adjustment area 54. When a tab for the development condition adjustment is selected, a development condition adjustment screen 71 is displayed as shown in FIG. 2. In the development condition adjustment screen 71, a tone curve correction section 72 for correcting a tone curve, a white balance correction section 73 for correcting a light source and a color temperature, an exposure compensation box 72 and a sensitization correction box 75 are displayed, for instance. Each development parameter is changed by clicking or dragging of the object after the cursor 47 is moved to an appropriate section with the mouse 33. When the development parameters are changed, temporary development is performed according to the changed development parameters. Thereby, newly generated simplified display image is displayed as the updated target image 51.

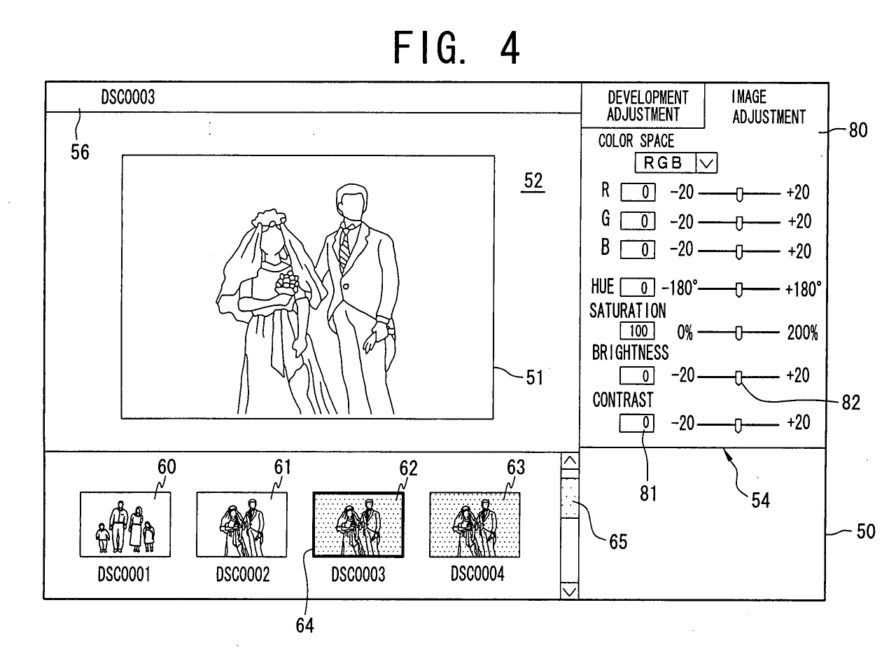

When the tab for the image adjustment is selected, an image adjustment screen 80 is displayed as shown in FIG. 4. In the image adjustment screen 80, the adjustment parameters, such as color balance, brightness and contrast, can be changed. Each adjustment parameter can be changed by inputting a value in an input box 81, which corresponds to each adjustment parameter, or moving an indicator 82 in the right and left sides. When each parameter is changed, the display image data, which corresponds to the target image 51, is subjected to the image correction, and the corrected image is displayed in the target image display area 52.

The development parameters are not limited to those for the tone curve and the white balance as shown in FIG. 3. For instance, it is possible to include parameters for sharpness correction. As for the adjustment parameters, it is also possible to include parameters for trimming correction in addition to the parameters shown in FIG. 4. Further, the combination of the development parameters and that of the adjustment parameters are not limited to the above embodiment. The combinations can be properly changed. For instance, it is possible to include the parameters for the color balance correction in the development parameters.

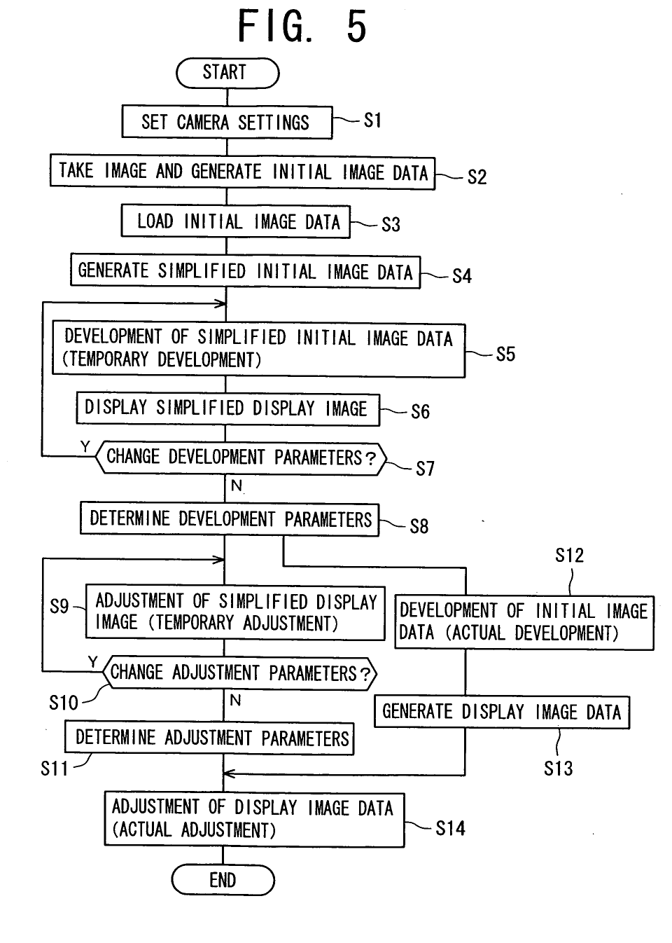

Steps of the image verification is described by using a flowchart in FIG. 5. The camera settings of the digital camera 10 is determined with the PC 30 for the image verification or the externally connected PC (S1). According to the determined camera settings, an image is taken by the digital camera 10 and the initial image data is generated (S2). The initial image data and the reduced image data are sent from the digital camera 10 to the PC 30 for the image verification via the communication cable 11 (S3).

According to the reduced image data, the loaded data is displayed in a list form in the reduced image display area 53 of the PC 30 for the image verification. The reduced images are displayed in black-and-white except for the reduced image, which has already been verified or excluded from the image verification, so as to prevent the incorrect color recognition of the operator during observation of the reduced image.

Then, simplified initial image data is generated by thinning out the corresponding initial image data of the image frame, which is selected by the operator, in a predetermined proportion (S4). The temporary development is applied to the simplified initial image data by using the initial development parameters (S5). The simplified display image, which is generated in the temporary development, is displayed as the target image 51 in the target image display area 52 (S6).

The operator observes the target image 51 and changes the development parameters, such as the tone curve and the color temperature (S7). When the development parameters are changed, the temporary development is performed to the simplified initial image data, so that the target image 51 is updated and displayed. That is, the steps S4 and S5 in FIG. 5 are repeated every time the development parameters are changed. The temporary development is performed to the initial image data which is previously thinned out in the predetermined proportion. As the data size of the initial image data is reduced, time for the temporary development can be reduced. Further, the display colors do not appear to be different, since the number of bits per color is the same as the initial image data, unlike the image data compressed in JPEG format. Consequently, the time for the development is effectively reduced while the quality of the display image avoids the degradation. The correction of the development parameters are completed and determined when the operator obtains the image with the quality as intended (S8).

After determining the development parameters, the simplified display image is displayed as the target image 51 in the verification screen 50 after being subjected to temporary development, and being corrected of the color balance, the contrast and the trimming by using the initial adjustment parameters (S9). The operator observes the verification screen 51 and changes the adjustment parameters (S10). When the adjustment parameters are changed, the image adjustments (the temporary adjustments), such as the color adjustment and the trimming, are performed to the simplified display image according to the simplified initial image data, and the target image 51 is updated and displayed.

In the above image adjustments, the simplified initial image data with smaller data size is used, so that time for updating and displaying the image can be reduced. Further, the development is not performed when changing the adjustment parameters, so that the time for updating and displaying the image can be reduced. The temporary adjustments are repeated, and when the operator obtains the intended result, the image adjustments are completed and the adjustment parameters are determined (S11).

Simultaneously with changing the adjustment parameters, the development of the initial image data is performed according to the determined development parameters in the background (S12), and the display image data is generated (S13). The time for the image verification is reduced, since the development of the initial image data is not necessary after the image adjustments. After the image adjustments, the image adjustments (actual adjustments), such as the color adjustments and the trimming, are performed to the display image data according to the determined adjustment parameters (S14). The display image data obtained by the actual adjustments is output as the verified image data.

In the above embodiment, the image verification is performed to each frame of the image data. However, it is possible to perform the above image verification to the plural frames. When shooting plural frames in a similar composition and similar shooting environment, the development parameters and the adjustment parameters for obtaining the excellent finished quality of the images as the operator intended remain approximately constant. Consequently, the time for the image verification is further reduced by omitting the steps of the temporary development and the temporary adjustments.

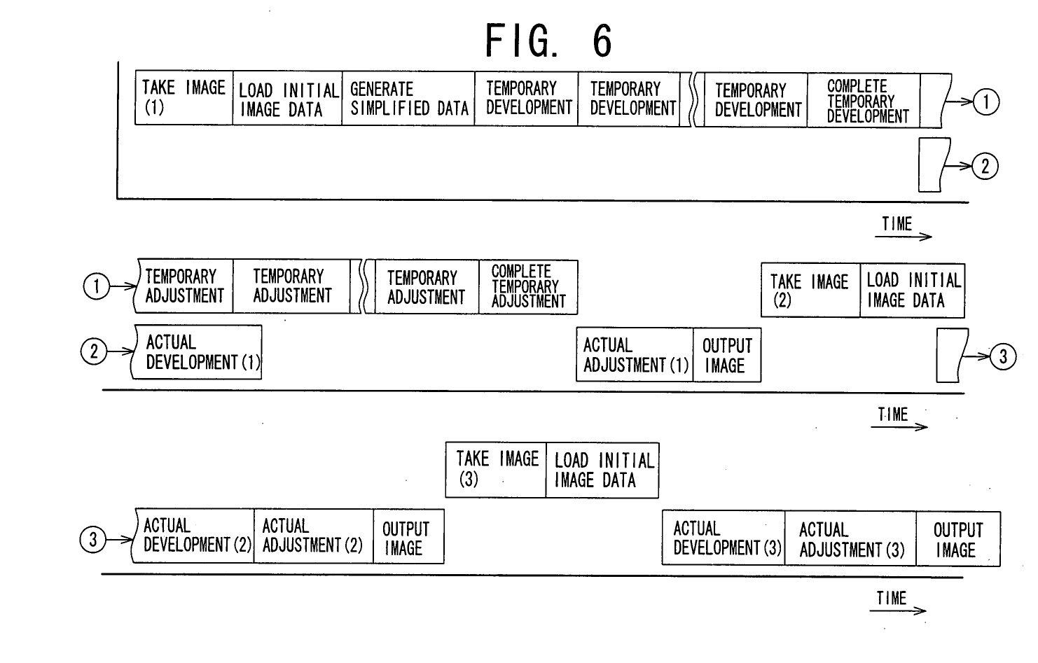

For instance, as shown in FIG. 6, the development parameters and the adjustment parameters for a first frame of the image are determined by repeating the temporary development and temporary adjustments as described in the flowchart of the FIG. 5. Next, a second frame is shot and the corresponding initial image data is output to the PC 30 for the image verification. Then, the development and the image adjustments are performed to the initial image data by using the development parameters and the adjustment parameters, which are determined in the image verification of the first frame. From a third and above frames, the development and the image adjustments are performed in the same way as the above. Thus, the image verification can be carried out automatically and completed in a short time. It is also possible to perform only the development to the initial image data, and that the operator repeats the image adjustments to determine the adjustment parameters.

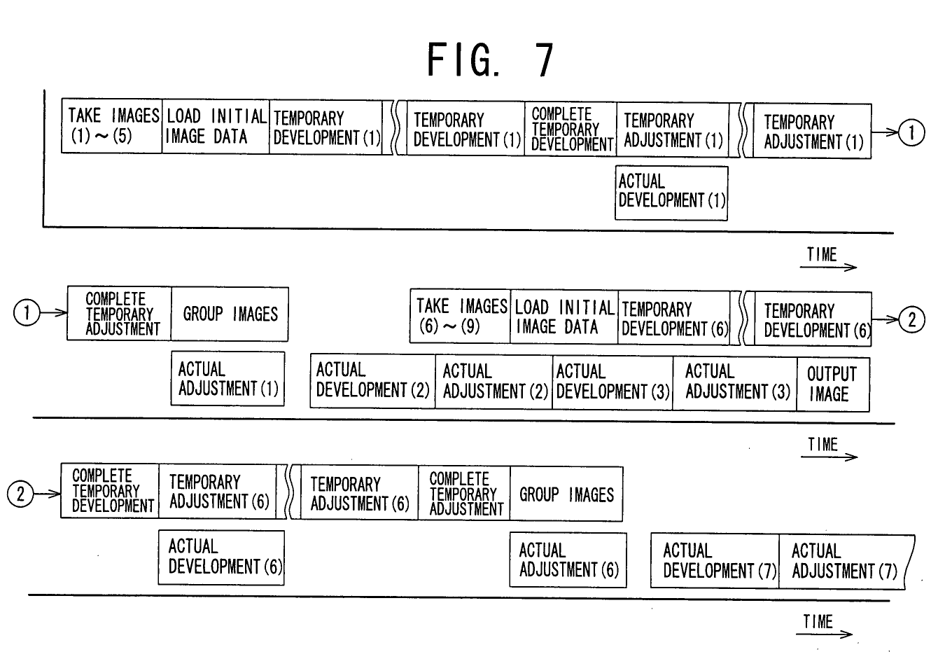

As shown in a time chart of FIG. 7, the shooting is repeated for plural times and plural frames of the initial image data (for instance, five frames in FIG. 7) is output. Then, the temporary development and the temporary adjustments are repeatedly performed to the first frame of the images in the same way as the above and the development parameters and adjustment parameters are determined. In an example shown in FIG. 6, the temporary development and the temporary adjustments are carried out by using the simplified initial image data which is generated by thinning out the initial image data in the predetermined proportion. Figures are omitted for the sake of convenience. When the temporary adjustments of the first frame is completed, other image frames to be subjected to the development and the image adjustments are selected by an operation of the operator. While selecting the image frames, the image adjustments are performed to the first frame of the initial image data according to the adjustment parameters.

Then, operator selects the image fames to be subjected to the image correction in the same conditions as the first frame. For instance, when the second and the third image frames are grouped, the development and the image adjustments are applied to the second and the third frames of the initial image data by using the development parameters and the adjustment parameters which are determined at the time of the image verification for the first frame. It is also possible to perform only the development to the initial image data and that the operator can determine the adjustment parameters after repeating the image adjustments.

From the second frame and on, it is possible to shoot next image during the development and the image adjustments. Then, a sixth to a twelfth frames of the image, for instance, are taken and the initial image data are output to the PC 30 for the image verification. The PC 30 for the image verification thins out the initial image data of the sixth frame to generate the simplified initial image data. The operator performs the image verification to the sixth frame in the same manner as the first frame. After the image verification, the operator selects the image frame to be corrected in the same conditions as the sixth frame. For instance, when a seventh to a tenth frames of the images are grouped, the initial image data of the seventh to the tenth frames are subjected to the development and the image adjustments by using the development parameters and the adjustment parameters determined at the image verification of the sixth frame. It is also possible to apply only the development to the initial image data and that the operator determines the adjustment parameters by repeating the image adjustments.

It is also possible to provide modes for performing the image processing in respective sequences shown in FIGS. 6 and 7, and such modes can be switched according to the shooting environment. When the shooting environment is constant, such as the studio shooting, for instance, the image processing can be automatically carried out by performing the sequence shown in FIG. 6 in accordance with the shooting. Further, when the shooting environment is likely to vary, the image processing is carried out by performing the sequence shown in FIG. 7. The image frames, which are to be subjected to the image processing, are processed by one operation, and the image processing for the image frames, which do not require the image processing, is skipped. Consequently, the image processing is effectively carried out.

In the above embodiment, the simplified initial image data is generated in the PC 30 for the image verification. However, it is also possible to generate the simplified initial image data in the digital camera 10 by thinning out the initial image data and outputting the simplified initial image data to the PC 30 for the image verification along with the initial image data.

Further, in the above embodiment, the development and the image adjustments are carried out in the PC 30 for the image verification. However, the development and the image adjustments can be carried out in a different terminal. Using the different terminal for the development prevents reduction in processing capacity of the PC 30 for the image verification during the image adjustments.

Although the present invention has been described with respect to the preferred embodiment, the present invention is not to be limited to the above embodiment but, on the contrary, various modifications will be possible to those skilled in the art without departing from the scope of claims appended hereto.

1. An image processing method for performing image correction to an initial image data obtained by shooting and for converting said initial image data into a display image data to output said display image data, said image processing method comprising:
(a) generating a simplified initial image data by thinning out said initial image data at a predetermined rate;
(b) performing image correction to said simplified initial image data according to a first correction parameter;
(c) generating a reproducible and displayable simplified display image based on said corrected simplified initial image data;
(d) enabling to change said first correction parameter by reproducing and displaying said simplified display image; and
(e) generating said display image data by performing image correction to said initial image data according to a determined first correction parameter.

2. An image processing method as claimed in claim 1, said step (d) further comprising the steps of:
(d1) performing image correction to said simplified initial image data according to a changed first correction parameter every time said first correction parameter being changed; and
(d2) reproducing and displaying said simplified display image which is generated from said corrected simplified initial image data.

3. An image processing method as claimed in claim 1, said image processing method further comprising the steps of:
(f) enabling to perform image correction to said reproduced and displayed simplified display image according to a second parameter after determining said first correction parameter; and
(g) performing image correction to said display image data according to a determined second, correction parameter.

4. An image processing method as claimed in claim 3, said step (f) further comprising the steps of:
(f1) performing image correction to said simplified display image according to a changed second correction parameter every time said second correction parameter being changed;
(f2) reproducing and displaying said corrected simplified display image.

5. An image processing method as claimed in claim 1, wherein said first correction parameter is changeable with respect to said initial image data corresponding to a first frame of an image, and image correction is performed to said initial image data corresponding to a second frame and on according to said determined first correction parameter.

6. An image processing method as claimed in claim 1, wherein said first parameter is changeable with respect to initial image data corresponding to one of plural frames obtained by plural shootings, and image correction is performed to initial image data corresponding to other selected images according to said determined first correction parameter.

7. An image processing method as claimed in claim 1, wherein one of a first processing mode and a second processing mode is selectable;
wherein said first processing mode enables to change said first correction parameter with respect to initial image data corresponding to a first frame of an image, and image correction is performed to initial image data corresponding to a second and above frames according to said determined first correction parameter; and
wherein said second processing mode enables to change said first correction parameter with respect to initial image data corresponding to one of plural images obtained by plural shootings, and image correction is performed to initial image data corresponding to said other selected images according to said determined first correction parameter.

8. An image processing method as claimed in claim 1, further comprising the step of:
reproducing and displaying reduced images corresponding to said initial image data, and displaying said reduced images corresponding to said initial image data, which have not been subjected to image correction, in black-and-white.

9. An image processing system including a shooting apparatus for shooting an object and generating initial image data, and an image processing apparatus for performing image correction to an image sent from said shooting apparatus, and outputting display image data by converting said initial image data into said displayable display image data, said image processing system comprising:
a data thinning section disposed in one of said shooting apparatus and said image processing apparatus, said data thinning section thinning out said initial image data at a predetermined rate to generate simplified initial image data;
said image processing apparatus comprising:
an image correction section for performing image correction to said simplified initial image data according to a correction parameter, and generating a reproducible and displayable simplified display image from said corrected simplified initial image data; and
an image display section for reproducing and displaying said simplified display image for enabling to change said correction parameter, wherein said image correction section performing image correction to said initial image data according to a determined correction parameter and generating said display image data.

10. An image processing apparatus for performing image correction to initial image data obtained by shooting, and outputting display image data by converting said initial image data into said displayable display image data, said image processing apparatus comprising:
a data thinning section for generating simplified initial image data by thinning out said initial image data at a predetermined rate;
an image correction section for performing image correction to said simplified initial image data according to a first correction parameter, and generating a reproducible and displayable simplified display image from corrected simplified initial image data; and
a reproduction and display section for reproducing and displaying said simplified display image for enabling to change said first correction parameter, wherein said image correction section poerforming image correction to said initial image data according to a determined first correction parameter and generating said display image data.

11. An image processing apparatus as claimed in claim 10, wherein said image correction section performs image correction to said simplified initial image data according to a changed first correction parameter every time said first correction parameter is changed, and generates said simplified display image according to said corrected simplified initial image data.

12. An image processing apparatus as claimed in claim 10, wherein said reproduction and display section enables to change a second correction parameter by reproducing and displaying said simplified display image after determining said first correction parameter, and said image correction section performs image correction to said display image data according to a determined second correction parameter.

13. An image processing apparatus as claimed in claim 12, wherein said image correction section performs image correction to said simplified display image according to a changed second correction parameter every time said second correction parameter is changed, wherein said reproduction and display section reproduces and displays said corrected simplified display image.

14. An image processing apparatus as claimed in claim 10, said reproduction and display section enables to change said first correction parameter with respect to said initial image data corresponding to a first frame of an image, wherein said image correction section performs image correction to said initial image data corresponding to a second frame and on according to said determined first correction parameter.

15. An image processing apparatus as claimed in claim 10, wherein said reproduction and display section enables to change said first correction parameter with respect to said initial image data corresponding to one of plural images obtained by plural shooting, wherein said image correction section applies image correction to initial image data corresponding to other selected images according to said determined first correction parameter.

16. An image processing program being installed in a computer, said image processing program functioning said computer as an image processing apparatus, said image processing program comprising the steps of:
(a) generating simplified initial image data by thinning out initial image data, which is obtained by shooting, at a predetermined rate;
(b) performing image correction to said simplified initial image data according to a first correction parameter;
(c) generating a reproducible and displayable simplified display image based on said corrected simplified initial image data;
(d) enabling to change said first correction parameter by reproducing and displaying said simplified initial image data; and
(e) generating said display image data by performing image correction to said initial image data according to a determined first correction parameter.
